(19) United States
(12) Patent Application Publication
(10) Pub. No.: US 2004/0017035 A1
(43) Pub. Date: Jan. 29, 2004

(54) Damper support having a contoured end face for a shock absorber of a motor vehicle

(76) Inventors: Christian Treder, Neustadt (DE); Stefan Zoufal, Dedensen (DE)

Correspondence Address: Walter Ottesen, Patent Attorney, P.O. Box 4026, Gaithersburg, MD, 20885-4026, US

(21) Appl. No.: 10/456,515

(22) Filed: Jun. 9, 2003

(30) Foreign Application Priority Data
Jun. 29, 2002 (DE) 102 29 287.6

(51) Int. Cl. F16F 7/00

(52) U.S. Cl. 267/220

(57) ABSTRACT

A damper support is provided which is especially for supporting shock absorbers in motor vehicles. The damper support is built in on the vehicle body between two clamping surfaces in axial direction of a piston rod of a shock absorber and is connected through a central opening to the piston rod of the shock absorber. At least one outer axial end face has at least one rise and one low in peripheral direction and the rises and lows of the outer axial end faces generate a waveform in the peripheral direction.

### FIELD OF THE INVENTION

The invention relates to a damper support which is especially for supporting a shock absorber in a motor vehicle. The damper support is built in on the vehicle body between two clamping surfaces in axial direction of the piston rod of the shock absorber and is connected to the piston rod of the shock absorber via a central opening.

### BACKGROUND OF THE INVENTION

A damper support of the kind referred to above is disclosed, for example, in German patent publication 201 18 533 U1. The damper support disclosed in this publication is made of polyurethane elastomers and is used in automobiles within the chassis. This application is generally known. Such damper supports are especially used as vibration-damping spring elements in motor vehicles. The spring elements (damper supports) assume the connection of the shock absorber to the vehicle chassis and/or to chassis components. With such an elastic coupling, vibrations are isolated which are caused by the roadway and transmitted via the wheel and shock absorber as well as such vibrations which are caused by the shock absorber itself. The coupling is so configured that cardanic movements of the shock absorber are made possible and the requirements in axial, radial and cardanic directions are satisfied.

German patent 199 28 599 discloses an elastic support for supporting a component and especially a bracing support for a spring structure. The support includes a housing which can be fixed to a carrier part. The housing has at least two housing parts connected to each other. In the housing, a damper element is mounted for accommodating a support plate connected to the component to be supported. The damping element functions to dampen movements between the component and the carrier part in a load direction. The housing parts are mounted next to each other to reduce the assembly tolerances in this load direction. At the axial end faces to the support plate, the damper element includes ribs and/or slots which run parallel to each other and perpendicular to the axis of the piston rod of the shock absorber and perpendicular to the load direction. In this way, the damping characteristics of the damper element can be adjusted and adapted to the peripheral conditions which are present in each case.

German patent publication 100 41 359 discloses an elastic support for bracing a component and especially a spring strut. The support includes a housing, which can be fixed on a carrier part, and this housing surrounds an inner part and a damping element supporting the inner part relative to the housing. The supporting component can be fixed to the inner part. The housing is configured as a one-piece cast part surrounding the damper element. With the one-piece configuration of the housing as a cast part, assembly tolerances are reduced and a high service life of the support is obtained. On the outer axial end faces, the damping element includes a series of recesses which run parallel to each other and perpendicular to the axis of the piston rod of the shock absorber. These recesses make possible a variation of the stiffness.

The axial characteristic of the damper support influences essentially the transmission of audible vibrations from the shock absorber into the vehicle body. The cylindrically-shaped embodiment having closed planar end faces of the damper support has been shown to be acoustically noticeable. This is caused by the high dynamic stiffness of this embodiment.

### SUMMARY OF THE INVENTION

It is an object of the invention to provide a damper support for a shock absorber in a motor vehicle which makes possible a good acoustic insulation between the shock absorber and the vehicle body and which optimally dampens the vibrations caused by the roadway and the shock absorber, especially the audible vibrations.

At least at one outer axial end face in peripheral direction, the damper support includes at least one high and one low and the highs and lows of the axial end face generate a waveform in the peripheral direction.

Mounting the damper support in the motor vehicle takes place in the manner of conventional damper supports. The damper support is clamped in the outer region to the vehicle body between two vehicle body fixed components which contact the outer axial end faces of the damper support. The damper support is connected to the piston rod of the shock absorber via a centrally-running bore. The waveform of the outer axial end face runs uniformly over the periphery. For this reason, the damper support lies with the rises or highs substantially uniformly against the particular clamping surface of the component fixed to the vehicle whereby a substantially uniform damping is obtained. An insert part is connected to the damping element of the damper support with the largest possible surface and this facilitates an optimization of the spring rate of the damper support with respect to an adaptation to the installation in a very specific vehicle and its matching to the chassis.

The advantage achieved with the invention is especially that the wave-shaped rises and lows in the peripheral direction of an outer end face of the damper support uniformly dampen the transmission of roadway vibrations transmitted by the shock absorber or vibrations which are caused by the shock absorber itself. The vibrations are minimized with respect to acoustic and acceleration in the vehicle chassis without consideration as to a specific orientation of mounting of the damper support. Advantageously, in the region of the lows, the axial end face is not in complete contact engagement with the clamping surface so that a smaller transmitting surface is present for the vibrations. A further advantage of the invention is that the axial characteristic line of the damper support can be influenced by the rises and lows in a progressive or degressive manner. A further advantage is that the waveform is configured symmetrically whereby the complexity of assembly of the damper support can be considerably reduced because an alignment is not needed.

According to another feature of the invention, the waveforms of rises and lows of the axial end face are sinusoidal, rectangular, triangular and/or trapezoidally shaped in the peripheral direction. With such a waveform, the damping of the damper support can be matched to a specific frequency range of the vibrations and especially to the acoustically audible frequency range. It is understood that the configuration of the rises and lows is not limited to a single waveform; rather, combinations of the given or additional waveforms with each other are possible.

According to another feature of the invention, the two outer axial end faces can have a waveform having at least one rise and one low. In this way, the two axial end faces of the damper support can be acoustically optimally decoupled at the clamping surfaces.

According to another feature of the invention, the rises or highs of the axial end faces contact the vehicle body fixed clamping surfaces in each operating state. The damper support is built in and journalled between these clamping surfaces in the axial direction of the piston rod of the shock absorber. In this way, impact noises of the damper support at the clamping surfaces can be avoided.

According to another feature of the invention, the rises are built in under pretension between the axially contacting clamping surfaces whereby a soft transition of the axial characteristic line of the damper support is generated so that, when there is a load change of the damper support from tension to compression or vice versa, an abrupt jump of the characteristic line is avoided which is acoustically advantageous. This is similar to impacts of the damper support at the particular clamping surface.

According to another feature of the invention, the rises of the one end face lie aligned in axial direction with the rises of the other end face and that the lows of the one end face lie aligned in axial direction with the lows of the other end face. In this way, and in a simple manner, an axial characteristic line of the damper support can be provided as if one had used a harder material. A further advantage of the embodiment of the invention is that the vibration damping can be matched in a simple manner to a very specific frequency range.

According to another feature of the invention, the rises of the one end face are aligned in axial direction with the lows of the other end face and the lows of the one end face are aligned in axial direction with the rises of the other end face. In this way, and in a simple manner, a softer axial characteristic line of the damper support is obtained. A further advantage of the invention is that the vibration damping can be matched in a simple manner to a very specific frequency range.

According to another feature of the invention, an even number of rises and lows per axial end face is present with which the vibration damping can be matched in a simple manner to a very specific frequency range. Another advantage of the invention is that the complexity of assembly is considerably reduced because of an alignment of the damper support during installation is not necessary.

According to another feature of the invention, an uneven number of rises and lows is provided per axial end face with which the vibration damping can be matched in a simple manner to a very specific frequency range. A further advantage of the invention is that the complexity of assembly is considerably reduced because an alignment of the damper support during installation is not necessary.

According to another feature of the invention, the damping element is made of elastomer and is preferably rubber. In this way, the damper support can be manufactured very cost effectively.

According to another feature of the invention, the damping element is made of a polyurethane elastomer (PUR). For this area of use, the elastomer is especially well suited with respect to material characteristics and can be cost effectively manufactured.

According to another feature of the invention, the damping element is made of Cellasto® material. Cellasto® material is suited for this area of application especially well with respect to the material characteristics. A considerably greater damping is noted especially for the inherent wheel frequency compared to conventional damper support materials. A further advantage of the invention is that the Cellasto® material has an especially low transverse expansion.

According to still another feature of the invention, more than one waveform per end face with different elevations of the highs and different depths of the lows is provided. In this way, the axial characteristic line of the damper support can be greatly changed above a defined deflection path. A further advantage of the invention is that the sign of the slope of the axial characteristic line is changed.

According to another feature of the invention, the rises and lows of at least two waveforms alternate in peripheral direction per end face whereby a symmetrical end face is provided which considerably reduces the installation and the complexity of assembly of the damper support. A further advantage of this embodiment of the invention is that the vibration damping can be matched in a simple manner to one or several frequency ranges.

According to another feature of the invention, the second or each additional waveform can be built in with a lesser elevation of the rises and with a lower or no pretensioning. In this way, the axial characteristic line of the damper support can be abruptly changed above a defined deflection path and especially the damping can be increased. A further advantage of this embodiment of the invention is that the sign of the slope of the axial characteristic line changes.

In a further embodiment of the invention, the waveform can be imaged on the clamping surface lying in contact engagement with the damping element. In this way, the damping element can be cost effectively manufactured from a rod material. A further advantage is the low complexity of assembly of the damping element or of the damper support because a complex alignment because of the waveform omitted on this component is unnecessary.

According to another feature of the invention, a bendable edge is provided as a contact or stop surface in the peripheral direction. The bendable edge makes possible an especially flat axial characteristic line of the damper support.

According to another feature of the invention, an insert part of metal or plastic is present and a planar connection to the damping element is provided. With this insert part, the durability of the damper support is significantly increased, especially the connection to the piston rod of the shock absorber. The connection of the insert part to the damping element should include the largest possible surface so that the characteristic line of the damper support can be changed in a simple manner.

According to another feature of the invention, the insert part is contoured to have a wave shape whereby the characteristic line of the damper support can be greatly influenced in the axial and radial directions.

According to another feature of the invention, the damping element has the following dimensions: an elevation of 22 to 30 mm; an outer diameter of 40 to 52 mm; an inner diameter of 25 to 35 mm; in the interior, a circular cutout having a diameter of 40 to 46 mm; and, an elevation of 7 to 13 mm. These combinations of magnitudes of the damping element are advantageously usable for a connection of the piston rod of a shock absorber to the vehicle chassis in the region of the forward axle of a motor vehicle.

According to another feature of the invention, the insert part is configured to have an annular shape and has the following dimensions: an elevation of 5 to 15 mm; an outer diameter of 40 to 46 mm; an inner diameter of 10 to 20 mm; and, a cone-shaped rise having an elevation of 5 to 15 mm and an outer diameter of 15 to 25 mm. This combination of sizes of the insert part is advantageously usable for a connection of the piston rod of a shock absorber to the vehicle chassis in the region of the forward axle of a motor vehicle.

According to another feature of the invention, the damping element has the following dimensions: an elevation of 28 to 36 mm; an outer diameter of 52 to 68 mm; an inner diameter of 30 to 45 mm; and, an inner circular cutout with a diameter of 46 to 60 mm and an elevation of 7 to 13 mm. This combination of size data of the damping element is advantageously usable for a connection of the piston rod of a shock absorber to the vehicle chassis in the region of the rearward axle of a motor vehicle.

According to another feature of the invention, the insert part is configured to have an annular shape and the following dimensions: an elevation of 5 to 15 mm; an outer diameter of 46 to 60 mm; an inner diameter of 10 to 20 mm; and, a cone-shaped rise having an elevation of 5 to 15 mm and an outer diameter of 15 to 25 mm. This combination of size data of the insert part is advantageously usable for a connection of the piston rod of a shock absorber to the vehicle chassis in the region of the rearward axle of a motor vehicle.

According to another feature of the invention, an air spring module is provided which is connected to a cover and an air-tight flexible member which is attached to the cover as well as a roll-off piston and a damper support which connects the piston rod of the shock absorber to the cover of the air spring module with the cover being fixed on the vehicle body. The roll-off piston is attached to a cylinder tube of the shock absorber and the flexible member rolls off on this cylinder tube. The damper support is tensioned in the air spring cover in the axial direction of the piston rod of the shock absorber between two damping surfaces. Furthermore, the air spring module includes an ancillary spring which is arranged concentrically to the piston rod and is guided in a guide ring which is fixedly connected to the cover and is braced at one end against this cover. At one axial end, the cylindrical tube of the shock absorber is attached to a wheel suspension and, at the other axial end, the cylindrical tube has a bore for the piston rod. For an almost complete deflection of the air spring module, the end face of the cylindrical tube braces against the ancillary spring. The air spring module serves for suspension and damping of vibrations in the motor vehicle.

The advantage achieved with the air spring module is especially that the wave-shaped rises and lows in the peripheral direction of an outer end face of the damper support uniformly dampen the transmission of roadway vibrations via the shock absorber or vibrations which are caused by the shock absorber itself so that the vibrations in the vehicle chassis are minimized with respect to acoustics and acceleration without consideration of a specific insulation orientation of the damper support.

### BRIEF DESCRIPTION OF THE DRAWINGS

The invention will now be described with reference to the drawings wherein:

FIG. 1 is a side elevation view, in section, of a damper support according to the invention;

FIG. 1a is a plan view of an end face of the damper support having a wave-shaped contour;

FIG. 2 is an example of an installation of the damper support;

FIG. 3 shows a rectangular-shaped contour of an end face;

FIG. 3a shows another contour of an end face;

FIG. 3b shows still another contour of an end face;

FIG. 4 shows a triangular-shaped contour of an end face;

FIG. 5 shows a sinusoidally-shaped contour of an end face;

FIG. 6 is a side elevation view, in section, of an air spring module incorporating the damper support;

FIG. 7 is a side elevation view of a damper support showing specific dimensions; and,

FIG. 8 is another damper support showing other specific dimensions.

### DESCRIPTION OF THE PREFERRED EMBODIMENTS OF THE INVENTION

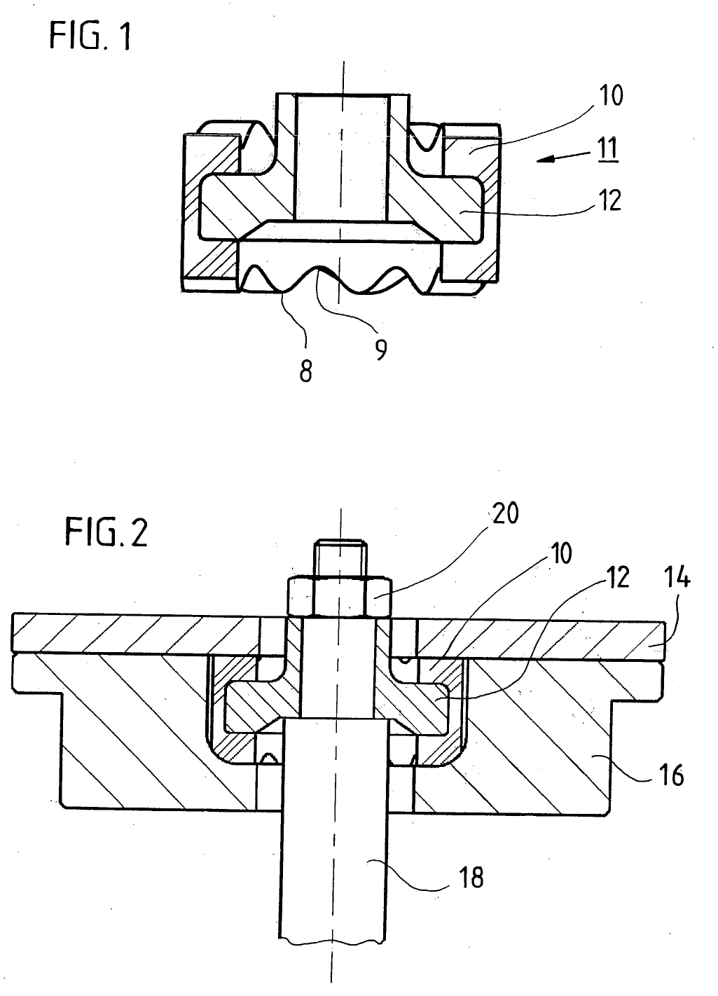

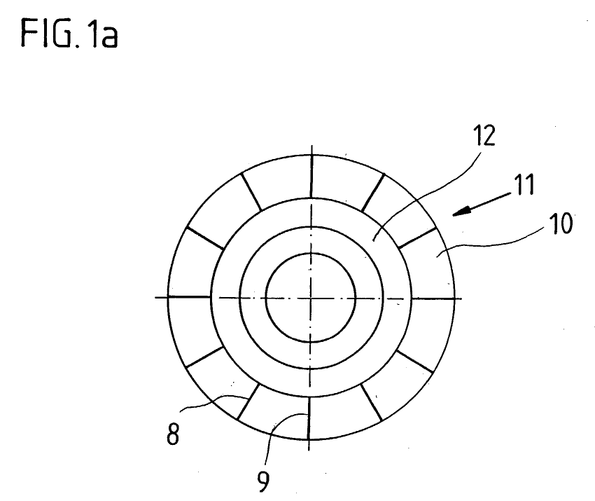

FIG. 1 shows a damper support 11 comprising a damping element 10 and an insert part 12. The damping element 10 is configured as an annularly-shaped component and is preferably made of an elastomeric material such as rubber or polyurethane foam. Both outer axial end faces of the damping element 10 have a sinusoidally-shaped waveform which is orientated in the peripheral direction. A circularly-shaped cutout for accommodating the insert part 12 is introduced in the center opening of the damping element 10. The insert part 12 is configured to have a hat-like shape with a center bore for passing through the piston rod. At one end, a conically-shaped flange is provided. At an axial end of the insert part 12, a recess is formed having a tapered region and then a planar extending surface. This configuration facilitates the passthrough of the piston rod of a shock absorber and the assembly thereof with the damper support 11. The insert part 12 is made of a material harder than the damping element 10 and is preferably metal or plastic.

FIG. 1a shows a schematic plan view of an end face of the damper support with the end face having a wave-shaped contour. The damper support 11 comprises the damping element 10 and the insert part 12. The wave shape runs in the peripheral direction. The highs 8 and the lows 9 are seen as elastic lines of a sinusoidally-shaped waveform, such as shown in FIG. 1, running in the peripheral direction of the damper support 11. A high 8 is surrounded by two lows 9 and, vice versa, a low 9 is surrounded by two highs.

FIG. 2 shows schematically the installation of the damper support. The insert part 12 is tightly connected to the piston rod 18 of a shock absorber by a nut 20 which threadably engages on the piston rod 18. The damping element 10 of the damper support is clamped in axial direction between a first plate 14 and a second plate 16. The outer axial end faces of the damping element 10 lie with the rises 8 against the corresponding clamping surfaces of the first and second plates (14, 16). The damping element 10 is built in between the two plates (14, 16) under a pretension so that the rises 8 slightly deform. The damping element 10 lies in radial direction only in the edge regions against the two plates (14, 16) so that the damper support cannot take up and transmit radial forces. The first and second plates (14, 16) are connected to each other via a conventional joining technique. For example, the plates are joined to each other using threaded fasteners or are pressed, welded or glued. In this embodiment of FIG. 2, the second plate 16 is provided with a pot-shaped cutout for accommodating the damper support and the first plate 14 is configured to be planar.

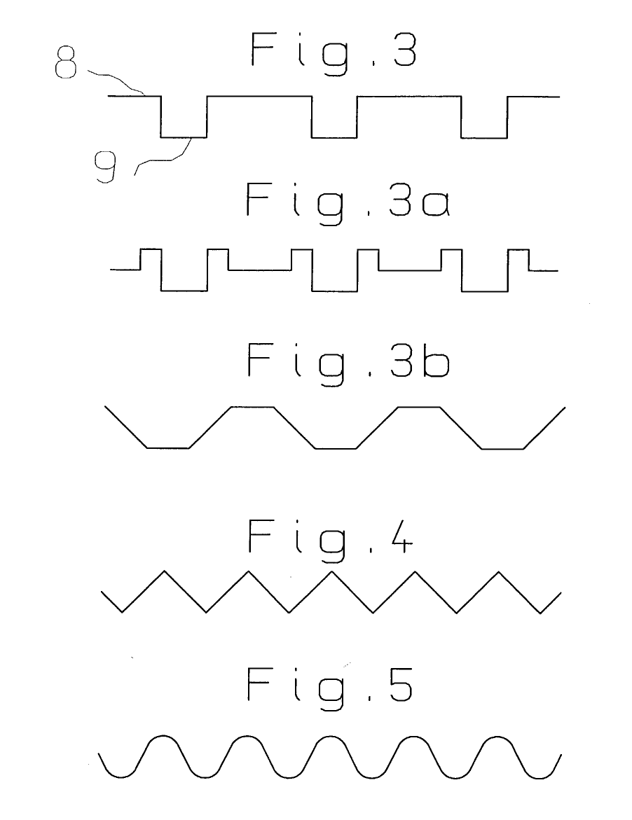

FIG. 3 shows a rectangularly-shaped waveform and how this waveform can be configured as the contour of an axial end face of the damping element 10 over the periphery. FIG. 3a shows schematically a rectangularly-shaped waveform having different elevations of the highs 8 and lows 9 and how this waveform can be configured as a contour of an axial end face of the damper support 11 over the periphery. FIG. 3b shows schematically a trapezoidally-shaped waveform as a combination of a triangularly-shaped waveform and a rectangularly-shaped waveform and how this waveform can be configured as a contour of an axial end face of the damping support 11 over the periphery. FIG. 4 shows schematically a triangularly-shaped waveform and how this waveform can be configured over the periphery as the contour of an axial end face of the damper support 11. FIG. 5 shows a sinusoidally-shaped waveform which describes the contour of an axial end face of the damper support 11 over the periphery. The contour of the outer axial end face of the damper support 11 is, however, not limited to the above-mentioned waveforms. Any desired combination of these waveforms as a new contour is conceivable. For example, the combination of a rectangularly-shaped waveform with a triangularly-shaped waveform can be used as a trapezoidally-shaped contour of the axial end face of the damper support or the contacting clamping surfaces or plates.

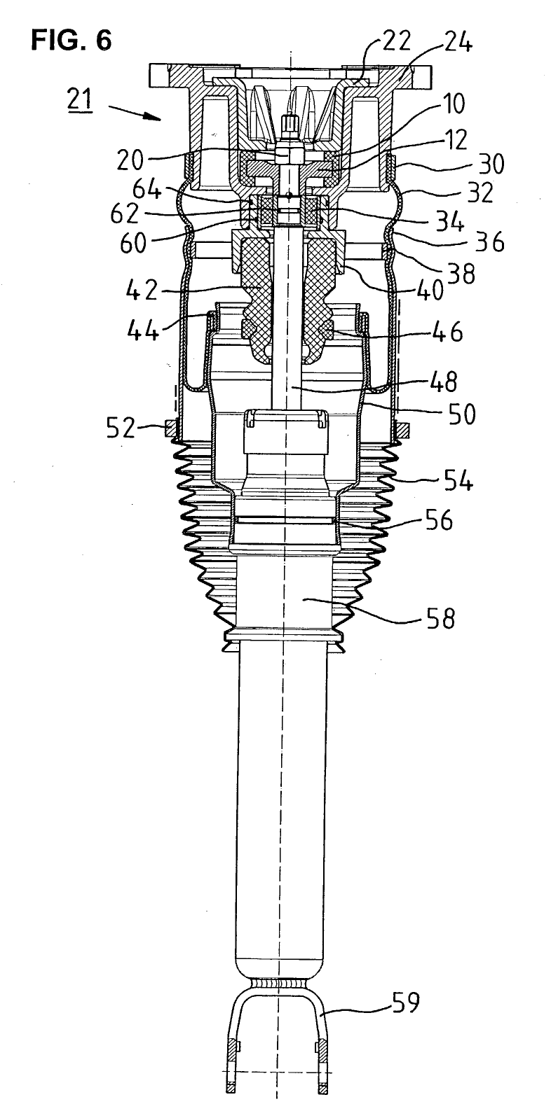

FIG. 6 shows an air spring module 21 which can be attached in motor vehicles preferably to the chassis at a first end and to a wheel suspension at a second end thereof. The air spring module comprises a cover 24 which is fixed to the chassis and a first end of a flexible member 32 which is attached air tight to the cover 24 with a clamp ring 30. The second end of the flexible member 32 is attached air tight with a clamp ring 44 to a roll-off piston 50. The roll-off piston 50 is connected air tight to the shock absorber tube 58 via an O-ring 56. A damper fork 59 can be attached to the wheel suspension and is preferably welded to the shock absorber tube 58.

The damper support is built into the cover 24 and comprises the elastic element 10 and the insert part 12. The axial pretension and fixation of the damping element 10 is achieved via a pressed-in closure pot 22. For damping the occurring radial vibrations, a radial damper support 34 is used which comprises an elastomeric part surrounded by an inner lying and outer lying plastic ring and/or metal ring. The radial damper support 34 is supported in axial direction against the piston rod 48 on the one hand and against the insert part 12 of the axial damper support on the other hand and is fixed by a nut 20 on the piston rod 48. An O-ring 62 seals the inner plastic ring and/or metal ring of the radial damper support 34 air tight to the piston rod 48. The outer plastic and/or metal ring is sealed air tight to a guide ring 40 via an O-ring 60. The guide ring 40 is fixed and preferably pressed into the cover 24 air tight via an O-ring 64. In the guide ring 40, an ancillary spring 42 is radially guided and fixed and is preferably pressed in. The ancillary spring 42 takes up additional tension and damping work when there is a complete axial deflection of the air spring module 21. An annularly-shaped support ring 46 is fixed in a slot of the ancillary spring 42 and increases the service life thereof.

An outer guide 36 is attached at a first end to the flexible member 32 with a clamp ring 38. A first end of a bellows 54 is attached with a clamp ring 52 to the second end of the outer guide 36. The bellows 54 protects the space of the rolling lobe of the flexible member 32 between the roll-off piston 50 and the outer guide 36 against penetrating dirt particles or the like. The second end of the bellows 54 is fixed to the shock absorber tube 58 via an annularly-shaped step. The embodiment of the air spring module 21 is preferably used in the rear axle of motor vehicles.

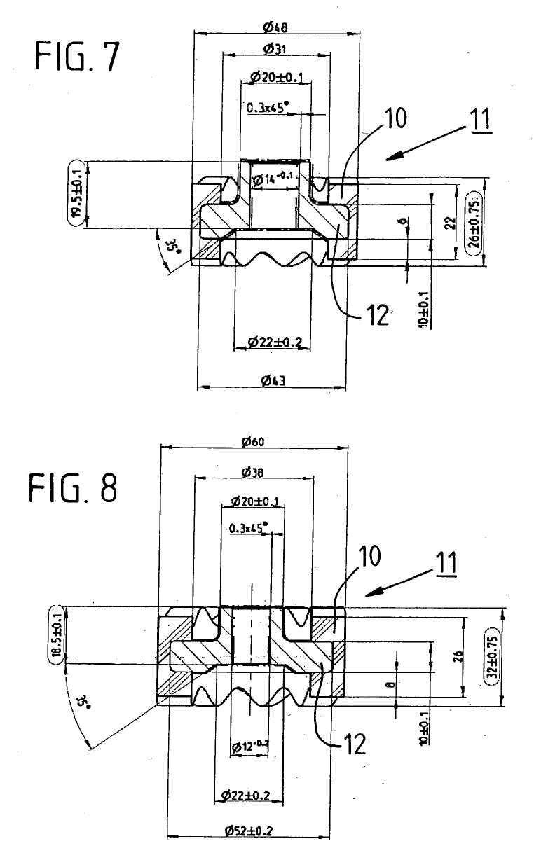

FIG. 7 shows a damper support 11 preferably installed in forward axle modules. The damper support 11 comprises an annularly-shaped damping element 10 preferably made of cellular polyurethane elastomer and an insert part 12 made of plastic or metal. The damping element 10 has especially an outer diameter of 40 to 52 mm (especially preferred, 48 mm); an elevation of 22 to 30 mm (preferably, 26 mm); a circular cutout on the inside having a diameter of 40 to 46 mm (preferably, 43 mm); an elevation of the cutout of 7 to 13 mm (preferably, 10 mm); and, a circular center opening having a diameter of 25 to 37 mm (preferably, 31 mm). The contours of the respective outer axial end faces have, in the peripheral direction, a sinusoidally-shaped waveform. The lows 9 of the first axial end face lie in axial direction above the rises 8 of the second axial end face and vice versa.

The insert part 12 is placed into the cutout of the damping element 10 and can be vulcanized in or foamed in. A largest possible contact surface between the damping element 10 and the insert part 12 is sought in order to be able to easily change the characteristic line of the damper support 11. The annularly-shaped insert part 12 includes: an elevation of 5 to 15 mm (preferably, 10 mm); an outer diameter of 40 to 46 mm (preferably, 46 mm); an inner diameter of 10 to 20 mm (preferably, 14 mm); and, at a first axial end, a conically-shaped rise having an elevation of 5 to 15 mm (preferably, 12 mm); and an outer diameter of the conically-shaped rise of 15 to 25 mm (preferably, 20 mm). At the second axial end, the insert part 12 includes a recess having a diameter of 18 to 26 mm (preferably, 22 mm) and an inlet bevel running outwardly from this diameter (especially at an angle of 30° to 40° and preferably 35°.

FIG. 8 shows a damper support 11 which is preferably used in rear axle modules. The damper support 11 comprises an annularly-shaped damping element 10 made preferably of cellular polyurethane elastomer and an insert part 12 made of plastic or metal. The damping element 10 has especially the following dimensions: an outer diameter of 52 to 68 mm (preferably, 60 mm); an elevation of 28 to 36 mm (preferably, 32 mm); a circularly-shaped cutout having a diameter of 46 to 60 mm on the inside (preferably, 52 mm); an elevation of the cutout of 7 to 13 mm (preferably, 10 mm); and, a circular center opening having a diameter of 30 to 46 mm (preferably, 38 mm). The contours of the respective outer axial end faces have a sinusoidally-shaped waveform in the peripheral direction. The lows 9 of the first axial end face lie over the rises 8 of the second axial end face in axial direction and vice versa.

The insert part 12 is placed in the cutout of the damping element 10 and is vulcanized in or foamed in. A largest possible contact surface between the damping element 10 and the insert part 12 is sought in order to be able to easily change the characteristic line of the damping support 11. The annularly-shaped insert part 12 has the following dimensions: an elevation of 5 to 15 mm (preferably, 10 mm); an outer diameter of 46 to 60 mm (preferably, 52 mm); an inner diameter of 10 to 20 mm (preferably, 12 mm); a conically-shaped rise on the first axial end having an elevation of 5 to 15 mm (preferably, 11 mm); and, an outer diameter of the conically-shaped rise of 15 to 25 mm (preferably, 20 mm). On the second axial end, the insert part 12 has a recess having a diameter of 18 to 26 mm (preferably, 22 mm) and an introducing bevel, which runs outwardly from this diameter and is especially at an angle of 30° to 40° (preferably, 35°).

It is understood that the foregoing description is that of the preferred embodiments of the invention and that various changes and modifications may be made thereto without departing from the spirit and scope of the invention as defined in the appended claims.

What is claimed is:

1. A damper support for supporting a shock absorber in a motor vehicle having a vehicle body, the shock absorber defining a longitudinal axis and including a piston rod and two holding members defining respective clamping surfaces, the damper support being mounted on said vehicle body along said longitudinal axis between said clamping surfaces and the damper support comprising:
a body defining a central opening for accommodating said piston rod;
means for connecting said piston rod to said body;
said body having at least one outer axial end face for coacting with one of said clamping surfaces;
said end face having a plurality of lows and highs formed thereon in a peripheral direction about said opening; and, said highs and lows alternating one with the other to define a waveform in said peripheral direction.

2. The damper support of claim 1, wherein said waveform has at least one of the following shapes: sinusoidal, rectangular, triangular and trapezoidal.

3. The damper support of claim 1, wherein said outer axial end face is a first outer axial end face and said damper support further comprises a second outer axial end face; and, said second outer axial end face also has a plurality of lows and highs formed thereon in a peripheral direction.

4. The damper support of claim 3, wherein said highs of said first outer axial end face are in contact engagement with said one clamping surface and said highs of said second outer axial end face are in contact engagement with the other one of said clamping surfaces.

5. The damper support of claim 4, wherein said highs are built in between said clamping surface under a pretension.

6. The damper support of claim 5, wherein said highs of said first outer axial end face lie above said highs of said second outer axial end face in the direction of said longitudinal axis; and, said lows of said first outer axial end face lie above said lows of said second outer axial end face.

7. The damper support of claim 5, wherein said highs of said first outer axial end face lie above said lows of said second outer axial end face in the direction of said longitudinal axis; and, said lows of said first outer axial end face lie above said highs of said second outer axial end face.

8. The damper support of claim 3, wherein there are an even number of highs and an even number of lows on each of said first and second outer axial end faces.

9. The damper support of claim 3, wherein there are an uneven number of highs and an uneven number of lows on each of said first and second outer axial end faces.

10. The damper support of claim 1, wherein said body includes a damping element defining said at least one outer axial end face and said damping element being made of elastomer.

11. The damper support of claim 10, wherein said elastomer is rubber.

12. The damper support of claim 10, wherein said elastomer is polyurethane elastomer (PUR).

13. The damper support of claim 10, wherein said elastomer is Cellasto® elastomer.

14. The damper support of claim 3, wherein said highs of each said first and second outer axial end faces are of different heights and said lows of each of said first and second outer axial end faces are of different depths.

15. The damper support of claim 3, wherein the highs and lows of at least two waveforms alternate on each of said first and second outer axial end faces.

16. The damper support of claim 15, wherein at least the second or each additional waveform is built in with lesser elevation of the highs thereof with slight or no pretension.

17. The damper support of claim 3, wherein the waveform on each of said outer axial end faces is also formed on the clamping surface corresponding thereto.

18. The damper support of claim 3, wherein said first and second outer axial end faces each define a bendable edge as a contact engaging surface to the corresponding clamping surface.

19. The damper support of claim 10, wherein said body further includes an insert part made of metal or plastic; and, connecting means for connecting said insert part to said damping element.

20. The damper support of claim 19, wherein said insert part is contoured so as to have a wave-like shape.

21. The damper support of claim 19, wherein said damping element is an annular member and has the following dimensions: an elevation of 22 to 30 mm, an outer diameter of 40 to 52 mm, an inner diameter of 25 to 35 mm; and, said annular member includes a circularly-shaped cutout having a diameter of 40 to 46 mm and an elevation of 7 to 13 mm.

22. The damper support of claim 21, wherein said insert part is formed as an annular element and has the following dimensions: an elevation of 5 to 15 mm, an outer diameter of 40 to 46 mm, an inner diameter of 10 to 20 mm; and, said insert part further including a lug-like rise having an elevation of 5 to 15 mm and an outer diameter of 15 to 25 mm.

23. The damper support of claim 19, wherein said damping element is an annular member and has the following dimensions: an elevation of 28 to 36 mm, an outer diameter of 52 to 68 mm, an inner diameter of 30 to 45 mm; and, said annular member includes a circularly-shaped cutout having a diameter of 46 to 60 mm and an elevation of 7 to 13 mm.

24. The damper support of claim 23, wherein said insert part is formed as an annular element and has the following dimensions: an elevation of 5 to 15 mm, an outer diameter of 46 to 60 mm, an inner diameter of 10 to 20 mm; and, said insert part further including a lug-like rise having an elevation of 5 to 15 mm and an outer diameter of 15 to 25 mm.

25. A shock absorber and air spring assembly for a motor vehicle having a chassis and a wheel suspension and said assembly being mountable between said chassis and said wheel suspension, the assembly comprising:
an air spring including: a cover unit attached to said chassis; a roll-off piston; and, a flexible member having a lower end portion attached to said roll-off piston to form a rolling lobe and an upper end portion attached air tight to said cover;
said flexible member enclosing a volume of air and deflecting over a spring path during operation of said assembly;
a shock absorber interposed between said cover and said wheel suspension;
said shock absorber including a cylinder and a piston disposed in said cylinder and having a piston rod;
said roll-off piston being arranged on said cylinder;
a damper support connecting said piston rod to said cover unit;
said cover unit defining two clamping surfaces for clamping said damper support in the axial direction of said piston rod;
a guide ring fixedly connected to said cover unit;
an ancillary spring arranged concentrically to said piston rod and guided in said guide ring;
said cylinder having a first end facing away from said damper support and said end being connected to said wheel suspension;
said cylinder having a second end supported against said ancillary spring when said assembly deflects in compression during operation thereof; and,
said damper support including:
a body defining a central opening for accommodating said piston rod;
means for connecting said piston rod to said body;
said body having at least one outer axial end face for coacting with one of said clamping surfaces;
said end face having a plurality of lows and highs formed thereon in a peripheral direction about said opening; and,
said highs and lows alternating one with the other to define a waveform in said peripheral direction.
